(19) United States
(12) Patent Application Publication
(10) Pub. No.: US 2008/0191604 A1
(43) Pub. Date: Aug. 14, 2008

(54) RETRO-EMISSION SYSTEMS COMPRISING MICROLENS ARRAYS AND LUMINESCENT EMITTERS

(75) Inventors: G. Michael Morris, Victor, NY (US); Stephen Chakmakjian, Madison, CT (US); Tasso R. M. Sales, Rochester, NY (US); Clinton T. Ballinger, Burnt Hills, NY (US); Michael LoCascio, Clifton Park, NY (US)

Correspondence Address: KENYON & KENYON LLP, RIVERPARK TOWERS, SUITE 600, 333 W. SAN CARLOS ST., SAN JOSE, CA, 95110, US

(73) Assignee: EVIDENT TECHNOLOGIES, Troy, NY (US)

(21) Appl. No.: 11/863,129

(22) Filed: Sep. 27, 2007

Related U.S. Application Data
(60) Provisional application No. 60/847,348, filed on Sep. 27, 2006.

(51) Int. Cl. H01J 1/62

(52) U.S. Cl. 313/499; 313/498; 977/950

(57) ABSTRACT

A method and system of retro-emission include a microlens array to focus light of a first wavelength on a layer of luminescent material configured to emit light of a second wavelength when excited by a light of the first wavelength.

### CROSS REFERENCE TO RELATED APPLICATION

The present application claims the benefit of co-pending U.S. provisional application Ser. No. 60/847,348, filed Sep. 27, 2006. The disclosure of the co-pending provisional application is incorporated herein by reference in its entirety.

### FIELD OF THE INVENTION

The present invention relates to retro-emission systems containing microlens arrays and luminescent emitters, and more specifically to retro-emission systems where the luminescent emitters consist of semiconductor nanocrystal complexes.

### BACKGROUND

Various kinds of lights are commonly used for assistance and guidance. For example, white lights on cars can be used to illuminate roads in low light or no light conditions, and colored lights on traffic signals can be used to deliver information such as whether a driver should stop or proceed. Lights can also be used to identify locations such as in the case of the lights used to illuminate a bridge as well as to identify the presence of a moving object such as in the case of automobile break lights. Numerous analogous uses of lights can also be found in a myriad of other industries and applications.

When a user of a light source, such as a spotlight or car headlights, illuminates an object it typically makes the object visible, but it does not present to the user any information other than the image of the illuminated object. Lights such as stop lights can deliver information, but they do not do so based on any sort of input from a user. Based on the foregoing limitations of current lighting systems, it would, therefore, be desirable to design a lighting system that allows an illuminated object to deliver information other than just its image as a function of the light used to illuminate the object. The present invention possesses this functionality, among others, which is missing from lighting systems currently known in the art.

### SUMMARY OF THE INVENTION

A retro-emission system embodying aspects of the present invention can include a microlens array, a layer of luminescent material, an illumination source, and a detection system configured to detect the light emitted by the luminescent material. Aspects of the present invention include using semiconductor nanocrystals as the luminescent material in the layer of luminescent material. Such a layer can be located on the back focal plane of a microlens array. The light emitted from the illumination source can be focused by the microlens array onto the luminescent material. The luminescent material can emit light isotropically at a second wavelength that is longer than the wavelength(s) emitted by the illumination source. The light generated by the luminescent material can be directed by the microlens back toward the direction of the illumination source, and may subsequently be detected by a detection system.

Another aspect of the present invention can include designing the retro-emission properties of the microlens array and luminescent material so that if the illumination source and a detection system are at sufficiently different angular positions with respect to a surface normal to the microlens array and the layer of luminescent material, then little or no emission radiation may be detected.

### BRIEF DESCRIPTION OF THE DRAWINGS

FIG. 1 depicts a uniform microlens array with square or substantially square microlenses.

FIG. 2 depicts a three-dimensional, theoretical surface profile of a microlens array.

FIGS. 3a-c depict plano-convex refractive lenses.

FIG. 4 represents an example retro-emission system embodying aspects of the present invention.

FIG. 5 depicts an example retro-emission system embodying aspects of the present invention.

### DETAILED DESCRIPTION

A retro emission system embodying aspects of the present invention can include a microlens array, a layer of luminescent material, an illumination source, which may serve as an optical pump for the layer of luminescent material, and a suitable detection system for the light emitted by the luminescent material.

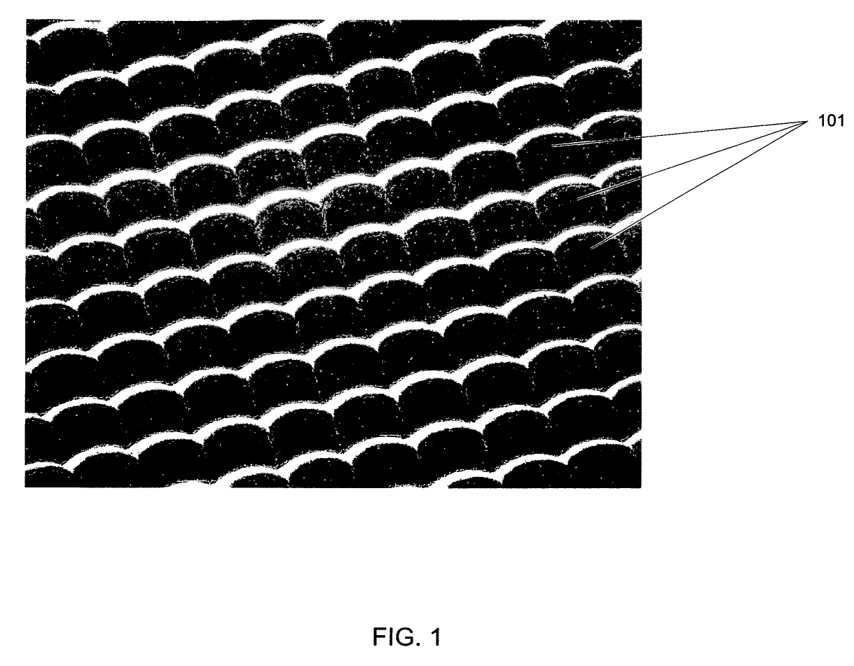

A microlens array of the present invention can be configured to focus light onto the layer of luminescent material. Microlens arrays suitable for a system embodying aspects of the present invention can comprise a plurality of unit cells arranged in a particular pattern, such as in a square, in a rectangle, or in a hexagon. A microlens can be located within each unit cell, with each microlens completely, or nearly completely, filling each unit cell. FIG. 1 depicts a uniform microlens array with square or substantially square microlenses, e.g. 101. Additionally, as can be seen in FIG. 1, the ratio of the area of the microlens to the area of the unit cell is close to 100% as no spaces can be seen. The lateral dimension of a given microlens might typically be between 10 μm and 500 μm.

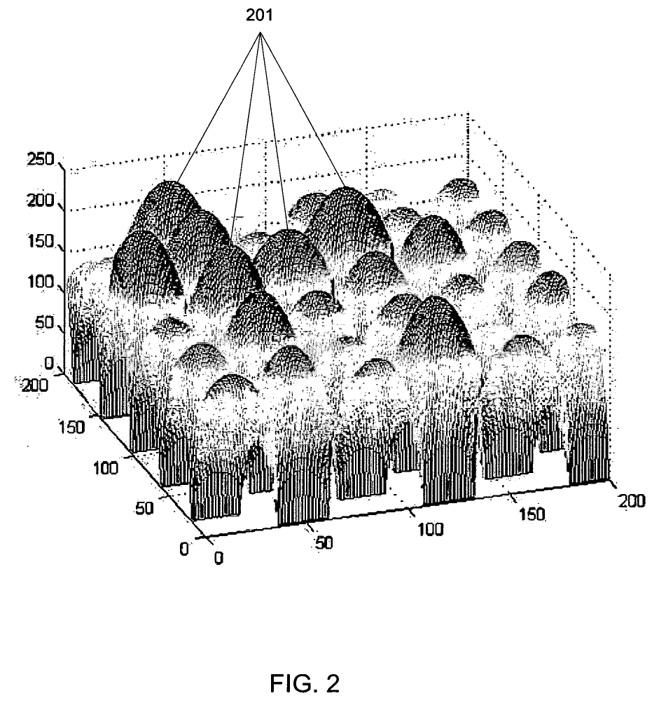

FIG. 2 depicts an example of a three-dimensional surface profile of a microlens array configured in an irregular pattern. Distributing different microlenses, e.g. 201, across an array in either a periodic or irregular pattern can be used to obtain wider detection angles with respect to the normal of the plane of the microlens array. Both uniform and non-uniform microlens arrays may be constructed such that each microlens 101 or 201 in the array focuses in the same focal plane.

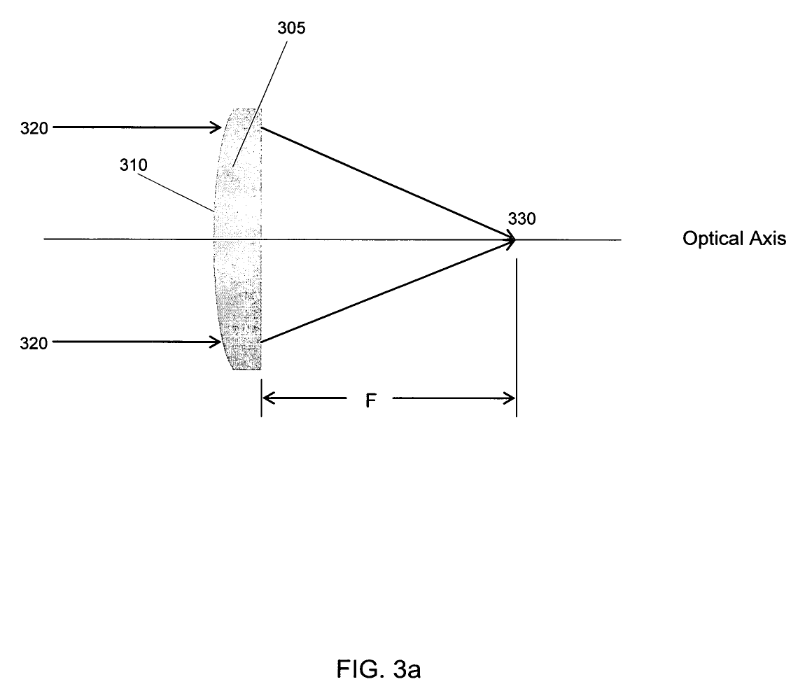

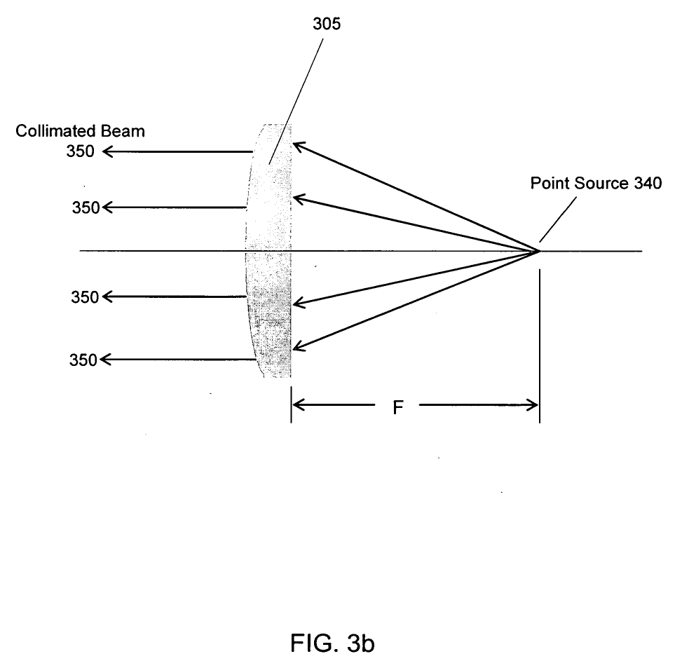

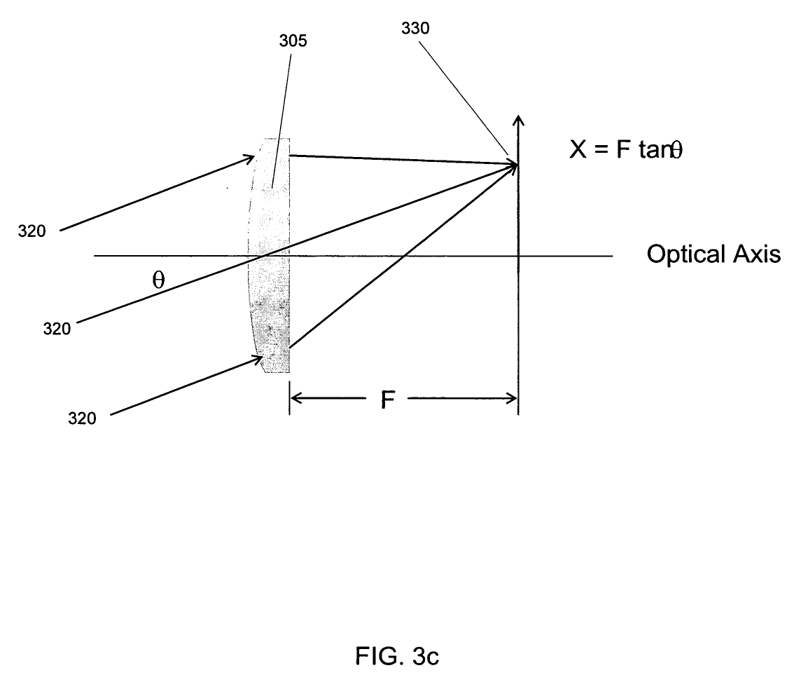

Each microlens 101 or 201 within the microlens array can be configured to focus light at a particular distance behind the lens. For example, each microlens 101 or 201 might be a plano-convex refractive lens 305 with a curved surface 310, as illustrated in FIG. 3a. The focal length (F) of the lens 305 can be obtained using the Lensmaker's equation—1/F=[n(λ)−1]/R—in which n(λ) denotes the index of refraction of the lens material at wavelength λ and R denotes the radius of curvature of the lens. If collimated light 320 is traveling along the optical axis from left to right, it will be focused to a point 330 on the optical axis at a distance F behind the lens 305. Conversely, as shown in FIG. 3b, if a point source of light 340 is placed a distance F behind lens 305, collimated light 350 (parallel rays) will emerge on the opposite side of the lens 305 traveling along the optical axis from right to left.

In a similar manner, as shown in FIG. 3c, if collimated light 320 is incident on the lens 305 at an angle θ with respect to the optical axis, the focal spot 330 will be centered at the location x=Ftanθ in the focal plane. And similarly, if a point source of light were located at the point x=Ftanθ 330 in the focal plane, it would create a collimated beam 320 traveling at angle θ with respect to the optical axis on the opposite side of the lens.

Focal length, which is function of the refractive index of the lens material and curvature of the lens can be varied. Additionally, each microlens may not be surrounded by air, but rather mounted on a substrate, which may have an index of refraction different than that of the microlens. Additional design considerations can arise as the incident angle θ gets larger. In such cases, optical aberrations, which distort the shape of the focal spot, become important and may need to be corrected by modifying the surface shape of the microlens or using other well known optical system design techniques.

The parameters of the microlenses may be adjusted to produce other desirable effects for particular applications. For example, a system designer may utilize different microlenses based on their numerical aperture (NA). High NA microlenses can provide higher brightness return signals and operate over wide fields of regard, which might be desirable depending on the application. Low NA can be used to produce high gain over narrower fields of regard or can be used to produce periodic regions of high gain at selected fields of regard.

Another parameter of microlenses that can be altered depending on design considerations is longitudinal chromatic aberration. The longitudinal chromatic aberration of a microlens can be selected to adjust the angular field of view of the return signal with respect to the optical axis of the illumination source. Microlenses exhibiting a small amount of longitudinal aberration will produce a return signal that has a narrow field of view, while microlenses that have a larger amount of longitudinal aberration will produce a return signal with a wider field of view. To adjust the effects of longitudinal chromatic aberration, a system designer can utilize a combination of crown- and flit-type materials to form an achromat, a diffractive-refractive hybrid lens, or one could potentially utilize a multi-order diffractive lens, see e.g. Faklis and Morris, U.S. Pat. No. 5,589,982, herein incorporated by reference in its entirety, to bring selected wavelengths to a common focus.

Another parameter of microlenses that can be adjusted depending on design considerations is anamorphic surface profile. Anamorphic microlenses, i.e., lenses in which focal length of the lens is different along the tangential and sagittal directions can be used to produce different fields of regard along the tangential and sagittal directions.

Now turning to the layer of luminescent material in a retro-emission system according to embodiments of the present invention, the luminescent material may be a semiconductor nanocrystal, a fluorescent dye, a phosphor, an up-converting phosphor, or a metal ligand complex. Regarding semiconductor nanocrystals (also known as a “quantum dots” or “QDs”), semiconductor nanocrystals are small, spherical, crystalline particles of typically II-VI, III-V, or IV-VI semiconductor materials consisting of thousands of atoms. At the upper end, a QD might be 20 nm diameter (200 A). Semiconductor nanocrystals can exhibit novel electronic properties due to what are commonly referred to as quantum confinement effects. These effects originate from the spatial confinement of intrinsic carriers (electrons and holes) to the physical dimensions of the material. One of the better known confinement effects is the increase in semiconductor band gap energy with decreasing particle size. Because the emission frequency of a nanocrystal can be dependent on the bandgap, one can control the output wavelength of a nanocrystal with great precision. In effect, it is possible to tune the bandgap of a nanocrystal, and therefore specify its color output, which can be desirable depending on the needs of a particular application.

In addition to emissive advantages, semiconductor nanocrystals also have advantages with respect to their absorptive properties. In contrast to bulk semiconductors which display a rather uniform absorption spectrum, the absorption spectrum for semiconductor nanocrystals appears as a series of overlapping peaks that get larger at shorter wavelengths. Due to the discrete nature of electron energy levels in nanocrystals, each peak corresponds to an energy transition between discrete electron-hole (exciton) energy levels. The nanocrystals will not absorb light that has a wavelength longer than that of the first exciton peak, also referred to as the absorption onset. Like all other optical and electronic properties, the wavelength of the first exciton peak (and all subsequent peaks) is a function of the composition and size of the nanocrystal with smaller nanocrystals resulting in a first exciton peak at shorter wavelengths.

The absorption spectra of the nanocrystals are dominated by a series of overlapping peaks with increasing absorption at shorter wavelengths. Each peak corresponds to an excitonic energy level, where the first exciton peak (i.e. the lowest energy state) is synonymous with the blue shifted band edge. Short wavelength light that is absorbed by the quantum dot will be down converted and reemitted at a shorter wavelength. The efficiency at which this down conversion process occurs can be denoted by the quantum yield. Nonradiative exciton recombination can reduce quantum yield due to the presence of interband states resulting from dangling bonds at the QD surface and intrinsic defects. Quantum yields can be greatly increased to nearly 90% in some circumstances by passivating the surface of the quantum dot core through the addition of a wide bandgap semiconductor shell to the outside of the nanocrystal.

The band gap and the resulting absorption onset and emission wavelength may be determined by the nanocrystals' composition and size. Each individual nanocrystal core emits a light with a line width comparable to that of atomic transitions. Any macroscopic collection of nanocrystals, however, emits a line that is inhomogeneously broadened due to the fact that every collection of nanocrystals is characterized by a distribution of sizes. Presently, semiconductor nanocrystals can be produced with size distributions exhibiting roughly a minimum variation in nanocrystal volume. This results in the width of the inhomogeneously broadened line which corresponds to ˜35 nm for CdSe, ˜70 nm for InGaP, and ˜100 nm for PbS.

Nanocrystal colloids may be synthesized through liquid phase chemical processes whereby metal-organic precursors and salts are combined in a heated surfactant bath. The precursors can dissociate and reassemble into clusters that grow over time. When the particles reach the desired size the reaction can be stopped by a raid drop in temperature. The resultant nanocrystals can be purified from excess surfactant and unreacted precursors through repeated precipitation steps. Often times an inorganic shell comprising a wide band semiconductor may be grown around the nanocrystal core using similar chemical processes. As mentioned above, inorganic shells may increase the quantum yield of the underlying semiconductor nanocrystal core by occupying defects and dangling bonds at the nanocrystal surface. Additionally, semiconductor shells can increase the environmental robustness of the nanocrystals.

Nanocrystal colloids can be enveloped by a layer of surfactant molecules having one or more functional groups that bind to the metal atoms comprising the quantum dots surface (examples include but are not limited to phosphine, phosphine oxide, thiol, and amine carboxylic acid) and one or more moieties opposite the metal groups that provide solubility to the nanocrystal in a given solvent or matrix material. For example hydrophobic aliphatic, alkane, alicyclic, and aromatic groups on the distal ends of the surfactant confers solubility in hydrophobic solvents, while the presence of polar or ionizable groups allow for the dispersal of the nanocrystals into hydrophilic and aqueous solvents.

Methods for exchanging the native surfactant (those present on the nanocrystal surface during synthesis) for alternative surfactants provided that those surfactants have the appropriate metal chelating groups (i.e. phosphine, phosphine oxide, thiol, amine, carboxylic acid etc.) are well established in the art. In general the process can involve stripping away the original surfactants through repeated solvent dilution and concentration steps in a centrifuge. By addition of the replacement surfactants to the stripped and concentrated nanocrystal pellets, the nanocrystals can be wrapped in the new surfactant and re-suspended into solvent. The replacement surfactant may provide solubility in a different type of solvent than allowed by the original surfactants.

Methods to disperse nanocrystals within solid polymeric materials are well established in the art. In general the process can include thoroughly dissolving a polymer (thermoplastic, silicone, sol-gel etc.) into a nanocrystal dispersion (nanocrystals suspended in a solvent) and then driving off the solvent to form a solid polymer/nanocrystal composite.

This composite in turn can be melted and formed into films and solid components through traditional polymer processing techniques such as injection and compression molding. Depending upon the polymer and other additives comprising the nanocrystal composite, the composite may be cross linked (UV or thermal initiation) and or thermally annealed to increase environmental robustness and/or reduce porosity.

It is also appreciated that the polymer/nanocrystal dispersion can be directly coated onto a substrate and dried to form a film. Nanocrystal composites may also be prepared by directly combining nanocrystals into uncured resins (such as epoxies), formed into the desired shape and cured. In a similar fashion, nanocrystal/dye complexes can be dispersed into polymers, epoxies, and silicones and deposited onto or formed into the luminescent layer component of the retro-reflection system.

Aspects of the present invention include configuring the layer of luminescent material and microlens arrays in order to take advantage of the reversibility of the microlens properties in order to send an optical signal back to the point of the light source from wide angles, allowing little signal to reach places other than the light source.

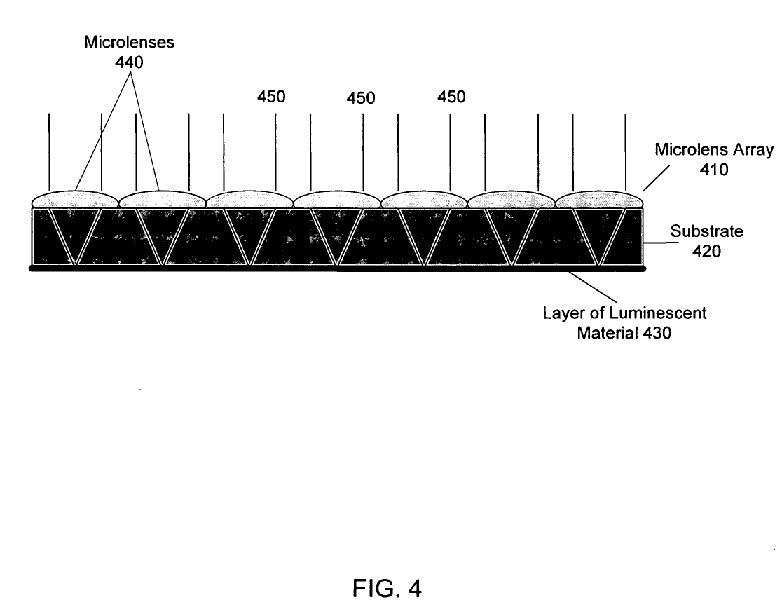

FIG. 4 shows an example of a retro-emission system embodying aspects of the present invention. The retro-emission system includes a microlens array 410, a substrate 420, and a layer of luminous material 430. The microlens array 410 can be formed on the top surface of the substrate 420. The microlenses, e.g. 440, and substrate 420 may or may not have the same index of refraction. Although identified as a substrate 420, the layer may consist of a vacuum, air, or a dielectric material wherein the dielectric material may be of the same material as the microlenses 440 or may be of a different dielectric material. The microlens array 410 and the substrate 420 can be any combination of polymer, glass or other suitable transparent materials. In one embodiment, the thickness of the substrate 420 may be selected so that the light 450 produced by an illumination source impinging on the microlens array 410 is focused at the back side of the substrate 420.

The layer of luminescent material 430 can be a luminescent material such as semiconductor nanocrystals, metal ligand complexes, organic dyes, rare-earth phosphors, or transition metal phosphors. The luminescent material can be dispersed in a thin film of transparent (or substantially transparent) matrix material including glass, silica, titania, alumina, silicones, sol-gel, PMMA, polystyrene, polyethylene, polycarbonate, or other transparent polymers, epoxies, or inks. Many luminescent materials, such as semiconductor nanocrystals, are sensitive to photooxidation and/or moisture, and/or acidic or basic pHs, free radicals and other reactive chemical species. Therefore a matrix material that a luminescent material is dispersed in may include an oxygen barrier and/or a moisture barrier. The layer of luminescent material 430 may emit light in the ultraviolet, visible, or infrared portion of the electromagnetic spectrum upon excitation.

If the substrate 420 is a solid dielectric material, the luminescent material may be directly deposited under the substrate layer 420 to create the layers of luminescent material 430, or the luminescent material may be dispersed in a thin film matrix material that is optically coupled to the substrate 420 to create a layer of luminescent material. Methods of affixing the layer of luminescent material 430 containing semiconductor nanocrystal material can include coating (printed, painted, etc.) on the back side of the substrate (i.e., in the focal plane of the microlens array), laminating, spraying, screen printing, flexographic printing, and ink jet printing.

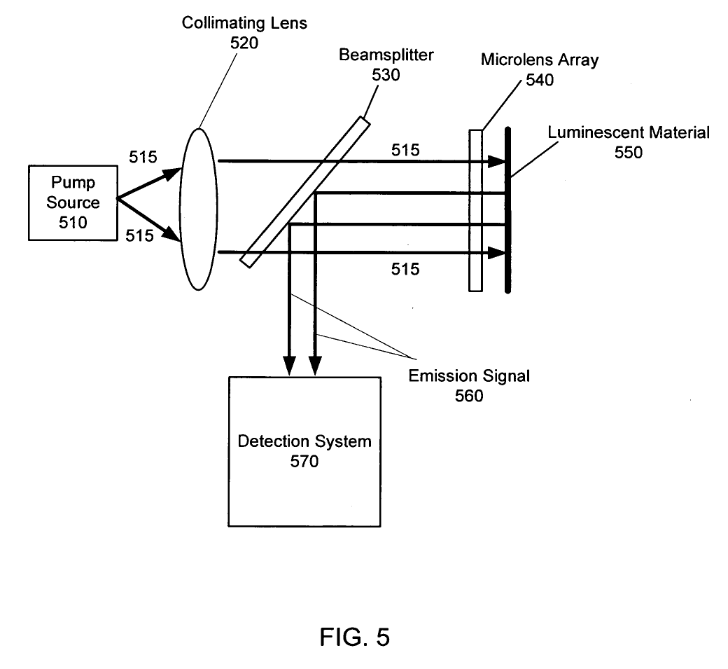

FIG. 5 shows another example of a retro-emission system embodying aspects of the present invention. The retro-emission system includes a pump source 510, a collimating lens 520, a beam splitter 530, and a microlens array 540 that focuses light 515 of a first wavelength from the pump source 510 onto a layer of luminescent material 550. Nonlimiting examples of optical pump sources 510 include lasers, laser diodes, LEDs, incandescent light sources, halogen lamps, gas discharge lamps, mercury vapor lamps, xenon lamps, and deuterium lamps.

The layer of luminescent material 550 produces an emission signal 560 at a second wavelength different than that emitted by the pump source 51 0. A substantial portion of the emission signal 560 emitted by the luminescent layer 550 can be directed back towards the pump source 510 via the microlens array 540 and can be detected using a suitable detection system 570. If the detection system 570 is not located at the same angle which the emission signal 560 is being directed, then a beam splitter 530 can be used to direct the emission signal 560 to the detection system 570. The beam splitter 530 can include a filter to separate the emissions signal 560 from other light, such as the light 515 being produced by the pump source 510.

As depicted in FIG. 5, the pump source 510 emitting light 515 of a first wavelength, is focused onto the layer of luminescent material 550 by the microlens array 540. The light of the first wavelength can excite the layer of luminescent material 550 causing it to emit light 560 of a second wavelength (i.e. an emission signal 560). The light 560 of a second wavelength produced by the layer of luminescent material 550 may be emitted isotropically. It will be readily apparent to one skilled in the art that although the present description makes references to light of a certain wavelength, the light 515 produced by the pump source 510 and the light 560 emitted by the layer of luminescent material 550 may actually be within a band of wavelengths.

The portion of the emitted light 560 that lies within the NA of a given microlens can be collimated by the microlens and returned in the direction of the pump source 510. Hence, a strong signal within the emission spectrum is observed being directed back toward the pump source 510 (retro-emission), which is substantially diminished, or nonexistent, at other observation angles. An element of this invention is that this strong retro-emission signal 560 can be observed over a wide range of angles of regard, see e.g. angle θ in FIG. 3c.

Depending on the particular application, luminescent materials may be selected to emit light 560 at wavelengths ranging from the infrared through visible portions of the spectrum. Because luminescent materials may be prepared and or purchased for many different wavelengths (semiconductor nanocrystal materials can be tuned to different emission wavelengths) and can be printed, using for example, ink-jet technology, a wide variety of color (emission) imagery can be generated using a single pump source 510.

A parameter that can characterize the performance of a retro-emission systems is the signal gain (G) which is defined as the ratio of the detected emission signal intensity obtained using the combination of the microlens array 540 and the luminescent material to the detected emission signal 560 intensity obtained using the luminescent material by itself. Using this invention, one can typically expect to achieve signal gains in the range of 10<G<20. Optimization of the optical design of the microlens array will result in higher gain values.

Aspects of the present invention can be implemented into a diverse set of applications. One such example of an application is identification systems. For example, in a night-time situation, one could, in effect, create a retro-emission badge or lettering on a jacket or other surface that emits an identification. For example, an individual might wear a badge that reads “FBI” when illuminated by a particular pump source. When the retro-emission badge or lettering is illuminated by a pump source (such as a solid-state laser mounted on the observer's helmet), the retro-emission badge or lettering would generate a bright (high gain) retro-emission that could be made to be either visible to the observer or detected by a suitable sensor and displayed to the observer. In such an application, the pump source might emit light at a wavelength outside the visible spectrum, thus only allowing individuals possessing a particular pump source to read the badge. Alternatively, when excited by a pump source, the badge may emit light at a wavelength outside the visible spectrum, thus allowing only individuals with a certain type of detection system, such as night vision goggles, to read the badge.

Another example of an application embodying aspects of the present invention includes counterfeit-deterrence and brand-protection systems. Semiconductor nanocrystals have the ability to act as an encrypting device for anti-counterfeiting because of their narrow and specifiable emission peaks and their excitation wavelength dependent emission intensity. With these traits, several different sizes (and therefore emission wavelengths) of dots can be combined with several different wavelengths of excitation light in order to create an almost infinite variety of emission spectra. Each of these spectra correspond to one coding combination, which can be made as arbitrarily complicated to duplicate as the encoder wishes. This process could, for example, work as follows.

Each semiconductor nanocrystal size corresponds to a given emission peak. If nanocrystals with different emission peaks are mixed together in known quantities, the resulting emission spectrum contains each emission peak present at some measurable intensity. This intensity can be dependent on both the quantity of nanocrystals present and the excitation intensity (or intensities, if several sources are used). By fabricating materials containing predetermined amounts of nanocrystals which emit at arbitrary wavelengths, and then establishing their emission spectra at arbitrary excitation wavelengths, one can create a “code” based on the relative intensities of emission peaks.

For example, if one combines equal amounts of 1000 nm, 1500 nm, and 2000 nm emission dots, and excites them at 800 nm, it might yield a different spectral code than unequal amounts of 1100 nm, 1600 nm, and 2100 nm emission dots excited at 900 nm. By changing the number of dots, their individual concentrations, their emission peaks, or their excitation wavelength, one can create and record a nearly unlimited variety of different spectral codes which can be easily inserted into, for example, plastic sheaths, inks, dyes, fabric, or paper, allowing for quantum dot anti-counterfeiting encryption.

The combination of the microlens array with the nanocrystal materials gives yet another feature that adds additional complexity, and thereby increases the difficulty to counterfeit and/or simulate the security or brand-recognition feature.

Another exemplary application of a retro-emission system embodying aspects of the present invention might be a bar-code scanning system. In such a system, the quantum dot material might be printed as a (1-D or 2-D) bar code onto the back side of a microlens array. In this application the strong (high gain) retro-emission signal is particularly well suited for scanning bar codes of distant objects, such as may be encountered in warehouse-type situations or other identification applications. In such an application, because semiconductor nanocrystal materials can be made to emit in a narrow spectral window, a narrow band filter might be used in conjunction with the detection system to improve the signal-to-noise ratio of the return signal.

Another exemplary application of retro-emission systems might be in the creation of multiple images. In such an application, different focal points formed by a given microlens can represent pixels located in different images. As the retro-emission device is viewed at different angles of regard, the observer might see an image corresponding to a particular viewing angle (angle of regard). A cylindrical (or lenticular) lenslet array may be used to produce a change in imagery along a single viewing axis, or an array of microlenses, such as those depicted in FIG. 1 may be used in the retro-emission device to produce changes in the imagery along any viewing axis with a two-dimensional (x,y) plane.

Another exemplary application of a retro-emission system embodying aspects of the present invention might be used for high brightness road signs and markers under night time driving situations. In such an application the headlights of a vehicle might serve as a pump source for the retro-emissive road sign or marker, with the high-gain emission signal generated by the luminescent material, such as a semiconductor nanocrystal, being directed back toward the driver and passengers in the vehicle, resulting in a vivid monochrome or color image in night-driving conditions.

The foregoing description and examples have been set forth merely to illustrate the invention and are not intended as being limiting. Each of the disclosed aspects and embodiments of the present invention may be considered individually or in combination with other aspects, embodiments, and variations of the invention. Further, while certain features of embodiments of the present invention may be shown in only certain figures, such features can be incorporated into other embodiments shown in other figures while remaining within the scope of the present invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention. Furthermore, all references cited herein are incorporated by reference in their entirety.

What is claimed is:

1. A retro-emission system comprising:
a microlens array configured to focus light of a first wavelength onto a layer of luminescent material; and
a layer of luminescent material configured to emit light of a second wavelength different from the first wavelength upon being illuminated by the light of the first wavelength.

2. The retro-emission system of claim 1, wherein the luminescent material comprises quantum dots, fluorescent dyes, phosphors, up-converting phosphors, or metal ligand complexes.

3. The retro-emission system of claim 1, wherein the luminescent material comprises quantum dots of II-VI, III-V, IV-VI, or I-III-VI group material.

4. The retro-emission system of claim 1, wherein the light of the second wavelength is in a visible or infrared spectrum.

5. The retro-emission system of claim 1, further comprising:
a detection system configured to detect light of the second wavelength.

6. The retro-emission system of claim 5, wherein a source of the light of the first wavelength and the detection system are located at a first angle and a second angle relative to a surface normal to the microlens array, and the emission intensity detectable by the detection system decreases as the difference between the first angle and the second angle increases.

7. The retro-emission system of claim 1, further comprising:
a beam splitter to direct the light of the second wavelength to a detection system configured to detect light of the second wavelength.

8. The retro-emission system of claim 1, wherein the microlens array is further configured to collimate the light of the second wavelength.

9. The retro-emission system of claim 1, wherein the light of the first wavelength is produced by a source and the microlens array is configured to direct the light of the second wavelength band towards the source.

10. The retro-emission system of claim 1, wherein the luminescent material is embedded in a material selected from the group consisting of: glass, silica, titania, alumina, silicones, sol-gel, PMMA, polystyrene, polyethylene, polycarbonate, or transparent polymers or epoxies.

11. A retro-emission system comprising:
a substrate;
a microlens array configured to focus light of a first wavelength to a focal plane at a back end of the substrate; and
a layer of luminescent material at the back end of the substrate, the layer of luminescent material configured to emit light of a second wavelength different from the first wavelength upon being excited by the light of the first wavelength.

12. The retro-emission system of claim 11, wherein the luminescent material comprises quantum dots.

13. The retro-emission system of claim 11, wherein the luminescent material comprises quantum dots of II-VI, III-V, IV-VI, or I-III-VI group material.

14. The retro-emission system of claim 11, wherein the microlens array is further configured to collimate the light of the second wavelength band.

15. The retro-emission system of claim 11, wherein the luminescent material is embedded in a material selected from the group consisting of: glass, silica, titania, alumina, silicones, sol-gel, PMMA, polystyrene, polyethylene, polycarbonate, or transparent polymers or epoxies.

16. The retro-emission system of claim 11, wherein the microlens array is embossed on the substrate and the substrate has a thickness approximately equal to a focal length of the microlens array.

17. The retro-emission system of claim 11, wherein the layer of luminescent material is a cured resin comprising nanocrystals.

18. The retro-emission system of claim 11, wherein the layer of luminescent material is optically coupled to the substrate.

19. The retro-emission system of claim 11, wherein the layer of luminescent material is a coating on the back side of the substrate.

20. A method comprising:
focusing with a microlens array light of a first wavelength to a focal plane; and
exciting with the light of the first wavelength a luminescent material to emit light of a second wavelength.

21. The method of claim 20, further comprising:
collimating with the microlens array the light of the second wavelength.

22. The method of claim 20, further comprising:
directing the light of the second wavelength towards a source of the light of the first wavelength.

23. The method of claim 20, wherein the light of the second wavelength is in an visible or infrared spectrum.
